(19) United States
(12) Patent Application Publication
(10) Pub. No.: US 2008/0241548 A1
(43) Pub. Date: Oct. 2, 2008

(54) LAMINATED MATERIAL AND METHOD FOR PRODUCING THE SAME, WAVE PLATE, AND OPTICAL FILM

(75) Inventors: Hideki Terashima, Miyagi (JP); Yoshiyuki Maekawa, Hokkaido (JP); Kouichi Satoh, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/047,242

(22) Filed: Mar. 12, 2008

(30) Foreign Application Priority Data
Mar. 15, 2007 (JP) 2007-066535

(51) Int. Cl. B32B 37/00; B32B 9/04

(52) U.S. Cl. 428/411.1; 156/272.2

(57) ABSTRACT

A laminated material, method for producing thereof, wave plate, and optical film are provided. A laminated material includes a plurality of members bonded together, each of the members including a polymer material. At least one of bonded surfaces of the members bonded together is subjected to a corona treatment.

### CROSS REFERENCES TO RELATED APPLICATIONS

The present application claims benefit of priority of Japanese patent Application No. 2007-66535 filed in the Japanese Patent Office on Mar. 15, 2007, the entire contents of which are incorporated herein by reference.

### BACKGROUND

The present application relates to a laminated material and a method for producing the same, a wave plate, and an optical film. More particularly, the present application relates to a laminated material including a polymer material.

In liquid crystal displays and others, various optical members, such as a polarizing film, a retardation film, or a wave plate, are used. Generally, such optical members are bonded together to form a laminated material. As a method for bonding the optical members together, there has generally been used a method in which the optical members are bonded together using a bonding agent, such as an adhesive, a photo-curing bonding agent, or a heat-hardening bonding agent.

Optical members composed of a polymer material, especially optical members composed of a cyclic olefin resin, are difficult to bond together. Thus, as a method for bonding the optical members composed of a cyclic olefin resin, a method has been proposed in which the surface of the optical member is subjected to ionizing radiation treatment, such as electron beam treatment, low-temperature plasma treatment, or corona treatment, to improve the bonding strength of a bonding agent (see, for example, Japanese Unexamined Patent Application Publication No. 2006-297751).

A wave plate constituting retardation films bonded together causes strain or deformation due to stresses when the wave plate is continuously used for a long term, so that the phase difference in the wave plate gradually changes (retardation). For solving this problem, a method in which the retardation films are bonded using a plurality of bonding agents having different physical properties has been proposed (see, for example, Japanese Unexamined Patent Application Publication No. 2005-208588).

Furthermore, as a method for bonding optical members together without using a bonding agent, there have been known methods in which the surfaces of the optical members are melted to bond the optical members together, such as a solvent welding method, a thermal welding method, and an ultrasonic welding method.

However, the laminated material constituting optical members is used in optical applications, such as a liquid crystal display, and hence, when a bonding agent layer exists between the optical members as described above, it is difficult to obtain satisfactory optical performance of the laminated material. For example, when the refractive index of the optical member and the refractive index of the bonding agent layer are not equal, reflection of light occurs at the bonding interface, so that the laminated material cannot obtain a desired transmittance. Further, a difference in coefficient of linear thermal expansion between the optical member and the bonding agent layer causes stresses in the laminated material in an environment at a high temperature or at a high temperature and a high humidity, so that the optical member is likely to peel off. In addition, it is difficult to select an optimal bonding agent for preventing such peeling of the optical member.

In the above-mentioned method in which the optical members are bonded together without using a bonding agent, the surface of the optical member is melted and welded, and therefore optical design is needed in taking into consideration the thickness of the layer to be welded, and it is very difficult to control the thickness of this layer.

### SUMMARY

Accordingly, it is desirable to provide a laminated material in that the members constituting the laminated material are bonded together without using a bonding agent and without melting the members, and a method for producing the same, a wave plate, and an optical film.

Based on experimental studies it has been found that, when the surface of a member to be bonded is subjected to corona treatment and then the members are put into close contact with each other, satisfactory bonding force can be obtained, and the present invention has been completed.

In accordance with an embodiment, there is provided a laminated material including a plurality of members bonded together, each of the members including a polymer material, in which at least one of the surfaces of the members bonded together is subjected to a corona treatment.

In accordance with an embodiment, a method for producing a laminated material including the steps of subjecting to corona treatment a surface of at least one of two members, each of the two members including a polymer material, and bonding the two members together through the surface subjected to the corona treatment.

In the laminated material according to an embodiment, the plurality of members may be composed of one type or two or more types of members. The polymer material constituting the members may be a cyclic olefin resin. At least one of the plurality of members may be a retardation film. At least one of the members may have an uneven surface bonded to another member. The members may have peel strength of 1.1 N/20 mm to 2.4 N/20 mm.

The wave plate according to an embodiment includes the above laminated material. The optical film according to an embodiment of the present invention includes the above laminated material.

In the method for producing a laminated material according to an embodiment, the corona treatment is preferably conducted at discharge energy of 500 W/m²/min to 30,000 W/m²/min, more preferably 1,000 W/m²/min to 20,000 W/m²/min, further preferably 1,700 W/m²/min to 20,000 W/m²/min.

In the method for producing a laminated material of according to an embodiment, the step for bonding may be performed while subjecting at least one of the two members to heat treatment, or the method further includes, after the step for bonding, subjecting to heat treatment at least one of the two members bonded together. In this case, the heat treatment may be conducted at a temperature of 40° C. or higher and equal to or lower than the glass transition temperature Tg of the polymer material constituting the member.

In an embodiment, a member having a surface activated by a corona treatment is bonded to another member, and therefore it is presumed that the surfaces of the members are chemically bonded to each other.

Additional features and advantages are described herein, and will be apparent from the following Detailed Description and the figures.

### BRIEF DESCRIPTION OF THE FIGURES

FIG. 1 is a diagrammatic view showing the first example of a laminated material according to a first embodiment.

FIG. 2 is a diagrammatic view showing the second example of a laminated material according to a second embodiment.

FIG. 3 is a diagrammatic view showing the construction of a test specimen used in the peel test in the Examples.

FIG. 4 is a diagrammatic view showing the peel test in the Examples.

FIG. 5 is a graph showing the relationship between the discharge energy of the corona treatment and the peel strength in Examples 1 and 6 to 8 and Comparative Examples 1, 3, and 4.

### DETAILED DESCRIPTION

Hereinbelow, embodiments will be described with reference to the accompanying drawings.

### (1) First Embodiment

(1-1) Construction of Laminated Material

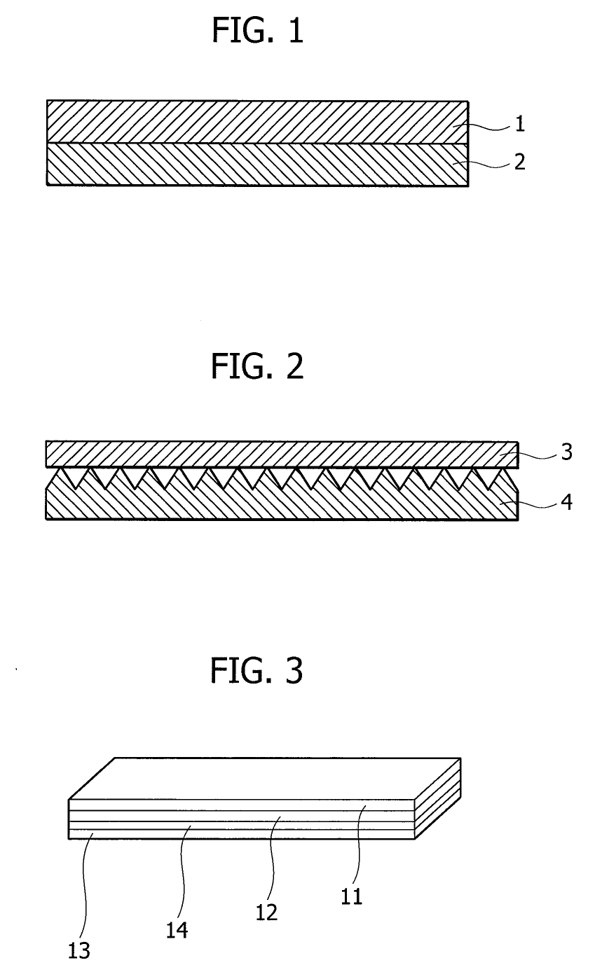

FIG. 1 shows an example of a laminated material according to a first embodiment. The laminated material is, for example, a laminated material for use in display, and, as shown in FIG. 1, includes a first optical member 1 and a second optical member 2. The first optical member 1 and the second optical member 2 are bonded together. The first optical member 1 and the second optical member 2 individually have, for example, a flat surface bonded to the other, and at least one of the surfaces of the optical members bonded to each other is treated by a corona treatment which is an ionizing radiation treatment.

Each of the first optical member 1 and the second optical member 2 is in the form of, for example, a film, a sheet, a plate, or a block. In the first optical member 1 and second optical member 2, for example, one type or two or more types of optical members may be used. Examples of the first optical member 1 and second optical member 2 include a retardation film, a polarizing film, a compensator film, a protecting film, and a supporting film.

Each of the first optical member 1 and the second optical member 2 includes a polymer material, and optionally an additive, and may further optionally include particles composed of a polymer material or an inorganic material. With respect to the polymer material, there is no particular limitation as long as it is a polymer material generally used, and, for example, polycarbonate (PC), polyethylene terephthalate (PET), polyethylene naphthalate (PEN), triacetylcellulose (TAC), polyvinyl alcohol (PVA), polypropylene (PP), polyarylate, polysulfone, polyether sulfone, an acrylic resin, or a cyclic olefin resin may be used. As a cyclic olefin resin, for example, ZEONEX (registered trademark), ZEONOR (registered trademark), which are trade names of Nippon Zeon Co., Ltd.; ARTON (registered trademark), which is a trade name of JSR Corporation; OPTOREZ (registered trademark), which is a trade name of Hitachi Chemical Co., Ltd.; or APEL (registered trademark), Which is a trade name of Mitsui Chemicals, Inc., may be used. As an additive, for example, at least one of a light stabilizer, an ultraviolet absorber, an antistatic agent, a flame retardant, and an antioxidant may be used.

(1-2) Method for Producing a Laminated Material

Next, an example of the method for producing a laminated material having the above-described construction is described.

Preparation of Optical Members

The first optical member 1 and second optical member 2 are first molded. As a method for molding the first optical member 1 and second optical member 2, for example, a solvent casting method or a melt extrusion method may be used. From the viewpoint of achieving excellent productivity, a melt extrusion method is preferably used. Then, if desired, the molded first optical member 1 and second optical member 2 are oriented by horizontal monoaxial orientation, vertical monoaxial orientation, or successive biaxial orientation, thus the refractive index of the first optical member 1 and second optical member 2 are controlled.

Corona Treatment

Next, at least one of the surfaces of the first optical member 1 and the second optical member 2 to be bonded to each other is subjected to corona treatment. For example, at least part of, preferably the whole of the surface of the optical member to be bonded is subjected to corona treatment. Alternatively, one of the surfaces of the first optical member 1 and the second optical member 2 to be bonded to each other is subjected to corona treatment, and another may be subjected to ionizing radiation treatment other than the corona treatment. Examples of ionizing radiation treatments other than the corona treatment include an electron beam treatment and a low-temperature plasma treatment.

A general corona discharge treatment apparatus may be used for the corona treatment. Specifically, an apparatus of, for example, a spark gap method, a vacuum tube method, or a solid state method may be used. The corona treatment is preferably conducted at discharge energy of 500 W/m²/min to 30,000 W/m²/min, more preferably 1,000 W/m²/min to 20,000 W/m²/min, further preferably 1,700 W/m²/min to 20,000 W/m²/min. When the discharge energy is 500 W/m²/min or more, satisfactory peel strength is obtained, and, when the discharge energy is 30,000 W/m²/min or less, the optical member is prevented from suffering deformation or change of properties. When the discharge energy is 1,000 W/m²/min or more, excellent peel strength is obtained, and, when the discharge energy is 20,000 W/m²/min or less, the film is more surely prevented from suffering deformation or change of properties. When the discharge energy is 1,700 W/m²/min or more, the peel strength is remarkably improved, and, when the discharge energy is 20,000 W/m²/min or less, the film may be further surely prevented from suffering deformation or change of properties. When the surface of the optical member to be bonded is subjected to corona treatment at discharge energy of 500 W/m²/min to 30,000 W/m²/min, the first optical member 1 and second optical member 2 bonded together have a peel strength of, e.g., 1.1 to 2.4 N/20 mm.

Bonding

The first optical member 1 and the second optical member 2 are then bonded together through the surface subjected to corona treatment. For obtaining strong bonding force, it is preferred that the first optical member 1 and the second optical member 2 are put into contact with each other while being pressed, or the first optical member 1 and the second optical member 2 are put into contact with each other and then they are pressed. It is preferred that the first optical member 1 and the second optical member 2 are put into contact with each other while heating, or are bonded together and then the resultant laminated material is subjected to heat treatment. It is preferred that the heating temperature is 40° C. or higher and equal to or lower than the glass transition temperature Tg of the polymer material constituting the first optical member 1 and second optical member 2. When the first optical member 1 and the second optical member 2 include different polymer materials, it is preferred that the heating temperature is 40° C. or higher and equal to or lower than the lower glass transition temperature Tg in the glass transition temperatures Tg of the polymer materials constituting the first optical member 1 and the second optical member 2. When the heating temperature is lower than 40° C., the peel strength is reduced, and, when the heating temperature is higher than the glass transition temperature Tg of the first optical member 1 and second optical member 2, the first optical member 1 and second optical member 2 are likely to suffer deformation. When at least one of the first optical member 1 and the second optical member 2 is a retardation plate (phase plate), a retardation film, or the like, it is especially preferred that the heating temperature is equal to or lower than the glass transition temperature Tg. When a retardation plate or retardation film is heated at a temperature higher than the glass transition temperature Tg, it may change not only in a shape but also in a phase difference. The optical members maybe bonded together at room temperature, and thus the above-mentioned heating step may be omitted as long as desired peel strength is obtained. The pressing and heating may be made using, for example, a hot laminator.

In the present specification, the heating temperature is defined as follows. When using a heating apparatus, such as a hot laminator which heats the optical members by bringing a heat source into contact directly with the optical members, the heating temperature means the surface temperature of a heat source such as a roll. When using a heating apparatus such as an oven, which heats the optical members by increasing the temperature of the atmosphere surrounding the optical members, the heating temperature means the temperature of the atmosphere near the optical members.

Thus, a desired laminated material is obtained. It is preferred that the step for corona treatment and the pressing or heating step for bonding are conducted by a roll-to-roll process since the productivity can be improved to reduce the production cost.

As mentioned above, in the first embodiment, at least one of the surfaces of the optical members to be bonded to each other is subjected to corona treatment, and the optical members are bonded together through the surface which has been subjected to corona treatment, and thus the optical members are bonded together without using a bonding agent and without melting the optical members. Accordingly, a laminated material having excellent optical properties and excellent reliability can be provided. In addition, no bonding agent is used and hence the cost for laminated material is reduced. Further, differing from a known method for producing a laminated material without using a bonding agent, i.e., a method for producing a laminated material by solvent welding, thermal welding, ultrasonic welding, or the like, a laminated material is produced without melting the surface of the optical member, making the optical design easy.

Further, in the first embodiment of the present invention, various optical members including a polymer material may be bonded together. For example, optical members including a cyclic olefin resin, which have been difficult to bond using a bonding agent, can be easily bonded together.

### (2) Second Embodiment

(2-1) Construction of Laminated Material

FIG. 2 shows an example of a laminated material according to the second embodiment. This laminated material is, for example, a laminated material for use in display, and, as shown in FIG. 2, includes a first optical member 3 and a second optical member 4. The first optical member 3 and the second optical member 4 are bonded together. At least one of the surfaces of the first optical member 3 and second optical member 4 bonded to each other is treated by a corona treatment which is an ionizing radiation treatment. The first optical member 3 has, for example, a flat surface bonded to the other, and the second optical member 4 has, for example, a regular or irregular uneven surface bonded to the other.

As the first optical member 3, the same optical member as the first optical member 1 in the first embodiment may be used. The second optical member 4 is, for example, a lens sheet or a lens film, and has a lens in the surface thereof bonded to the other member. Examples of lenses include a cylindrical lens, a prism lens, a fly-eye lens, a Fresnel lens, and a lenticular lens. As a material for the second optical member 4, for example, the same material as that for the second optical member 2 in the first embodiment may be used.

(2-2) Method for Producing a Laminated Material

The method for producing a laminated material having the above-described construction is substantially the same as the method in the first embodiment except that the first optical member 3 and the second optical member 4 are used as optical members.

In the second embodiment, optical members having an uneven surface, which are very difficult to bond by a known bonding method, is bonded together. Accordingly, a laminated material is produced using an optical member, such as a lens sheet or a lens film.

### EXAMPLES

The present application will be described in more detail with reference to the following; illustrative Examples, accordingly to an embodiment.

A corona treatment apparatus by the examples was prepared using a high-frequency power source and a discharge unit, manufactured and sold by KASUGA ELECTRIC WORKS LTD. The discharge electrode length is 250 mm, and conditions for the treatment were set from a feed rate of the film and discharge power.

In the present Examples, discharge energy of the corona discharge treatment apparatus was determined as follows.

Discharge energy=P(W)/{l(m)×v(m/min)}

Discharge electrode length: l(m)

Treatment speed: v (m/min)

Discharge power: P (W)

In the present Examples, peel strength was determined as follows.

For evaluating peel strength of a film laminated material, a test specimen having a form shown in FIG. 3 was prepared. This test specimen was prepared by bonding a film A (11) and a film B (12) together to form a sheet and cutting the sheet b) means of a cutter into a rectangular form having a width of 20 mm and a length of 100 mm. When conducting a test, the sheet specimen was fixed to a glass plate 13 having the same size as that of the specimen using an adhesive layer 14. In the test, only the film A (11) shown in FIG. 3 was peeled off the test specimen to measure a peel strength between the film A (11) and the film B (12). When peel strength is measured with respect to the test specimen as described above, the strength of the adhesive layer 14 for fixing the sheet specimen to the glass plate 13 needs to be higher than the bonding strength between the films.

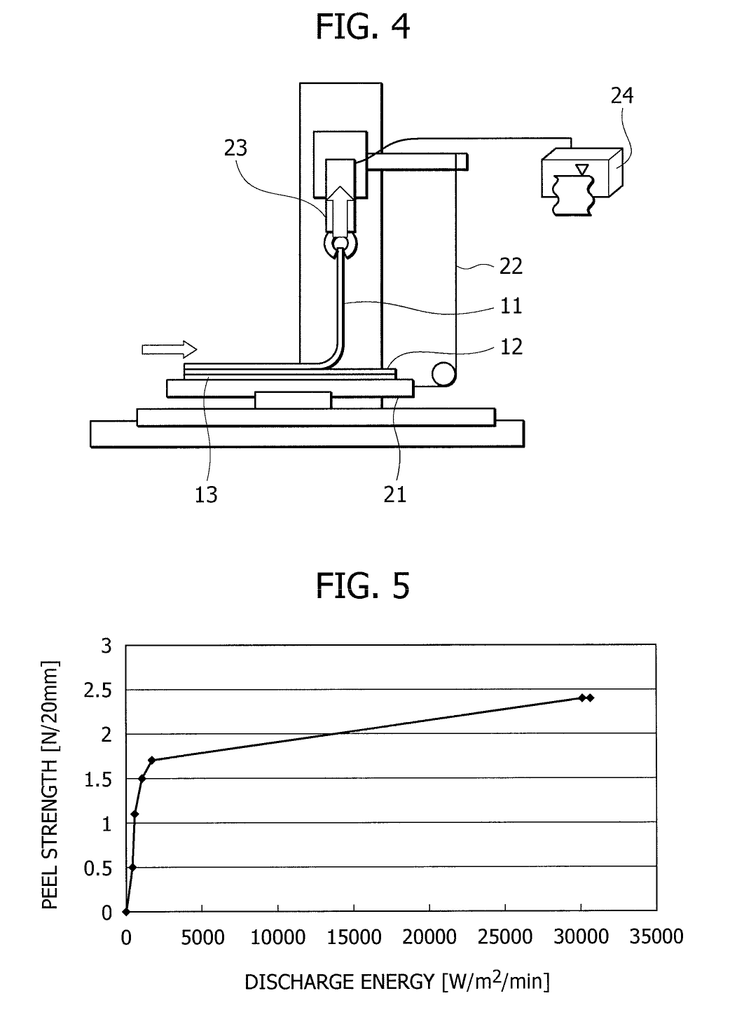

The test specimen prepared was then attached to into a test machine, and a 90° peel test was conducted. The 90° peel test used in the present Examples is diagrammatically shown in FIG. 4. As a test machine, tensile compression tester SV-55C-2H, manufactured and sold by Imada Seisaku-sho Co., Ltd., was used. A slide table 21, onto which a test specimen is placed and fixed, is connected to a driving system for measuring device through a wire 22, and has a structure such that the slide table is driven according to the elevation of a measuring probe 23. A pen recorder 24 is connected to the tester, and the pen recorder 24 records a curve of the load change with the passage of time.

In the present Examples, an oven temperature indicates the temperature of the atmosphere near a laminated material subjected to heat treatment.

### Example 1

Two cyclic olefin films each having a thickness of 80 μm were prepared, and the surfaces of the individual films were subjected to corona treatment at discharge energy of 1,700 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 2

A cyclic olefin film having a thickness of 80 μm and a PEN film having a thickness of 100 μm were prepared, and the surfaces of the individual films were subjected to corona treatment at discharge energy of 1,700 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 3

A cyclic olefin film having a thickness of 80 μm and a PC film having a thickness of 100 μm were prepared, and the surfaces of the individual films were subjected to corona treatment at discharge energy of 1,700 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 4

Two PEN films each having a thickness of 100 μm were prepared, and the surfaces of the individual films were subjected to corona treatment at discharge energy of 1,700 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 5

Two cyclic olefin films each having a thickness of 80 μm were prepared, and the surfaces of the individual films were subjected to corona treatment at discharge energy of 1,700 W/m²/min. Then, the films were bonded together so that the corona-treated surfaces faced each other to obtain a laminated material. In the bonding, the films were lightly pressed using a hand roller so that the films were in close contact with each other. Then, the laminated material obtained was subjected to heat treatment by placing it in an oven at 100° C. for one hour. The resultant laminated material was then cut into a specimen having a width of 20 mm and a length of 100 mm, and 90° peel strength (N/20 mm) was measured.

### Example 6

Two cyclic olefin films each having a thickness of 80 μm were prepared, and the surfaces of the individual films were subjected to corona treatment at discharge energy of 500 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 7

Two cyclic olefin films each having a thickness of 80 μm were prepared, and the surfaces of the individual films were subjected to corona treatment at discharge energy of 1,000 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 8

Two cyclic olefin films each having a thickness of 80 μm were prepared, and the surfaces of the individual films were subjected to corona treatment at discharge energy of 30,000 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Example 9

Two cyclic olefin films each having a thickness of 80 μm were prepared, and the surfaces of the individual films were subjected to corona treatment at discharge energy of 1,700 W/m²/min. Then, the films were bonded together so that the corona-treated surfaces faced each other to obtain a laminated material. In the bonding, the films were lightly pressed using a hand roller so that the films were in close contact with each other. Then, the laminated material obtained was subjected to heat treatment by placing it in an oven at 40° C. for one hour. The resultant laminated material was then cut into a specimen having a width of 20 mm and a length of 100 mm, and 90° peel strength (N/20 mm) was measured.

### Comparative Example 1

Two cyclic olefin films each having a thickness of 80 μm were prepared, and bonded together without a surface treatment to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Comparative Example 2

Two cyclic olefin films each having a thickness of 80 μM were prepared, and the surfaces of the individual films were subjected to corona treatment at discharge energy of 1,700 W/m²/min. Then, the films were bonded together using an acrylic ultraviolet hardening-type bonding agent to obtain a laminated material. The laminated material obtained was then cut into a specimen having a Width of 20 mm and a length of 100 mm, and 90° peel strength (N/20 mm) was measured.

### Comparative Example 3

Two cyclic olefin films each having a thickness of 80 μm were prepared, and the surfaces of the individual films were subjected to corona treatment at discharge energy of 400 W/m²/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

### Comparative Example 4

Two cyclic olefin films each having a thickness of 80 μm were prepared, and the surfaces of the individual films were subjected to corona treatment at discharge energy of 30,500 W/m/min. Then, the films were bonded together so that the corona-treated surfaces faced each other to obtain a laminated material. In the bonding, the films were lightly pressed using a hand roller so that the films were in close contact with each other. The laminated material obtained was then cut into a specimen having a width of 20 mm and a length of 100 mm, and 90° peel strength (N/20 mm) was measured.

The formulations of laminated materials, the conditions for preparation of the laminated materials, and the results of measurement in Examples 1 to 9 and Comparative Examples 1 to 4 are shown in Table 1. The relationship between the discharge energy of the corona treatment and the peel strength in Examples 1 and 6 to 8 and Comparative Examples 1, 3, and 4 is shown in FIG. 5. In Example 2, the test specimen was broken during the peel test, and the measurement of peel strength was impossible. In Comparative Example 4, deformation of the film was confirmed by visual observation.

TABLE 1

| | | Discharge | | Heat treatment | Peel | |
|---|---|---|---|---|---|---|
| | Films | energy | Bonding | temperature | strength | |
| | A/B | (W/m²/min) | agent | (° C.) | (N/20 mm) | Film deformation |
| Example 1 | A: Cyclic | 1,700 | None | — | 1.7 | Not observed |
| | olefin | | | | | |
| | B: Cyclic | | | | | |
| | olefin | | | | | |
| Example 2 | A: Cyclic | 1,700 | None | — | Broken | Not observed |
| | olefin | | | | | |
| | B: PEN | | | | | |
| Example 3 | A: Cyclic | 1,700 | None | — | 0.8 | Not observed |
| | olefin | | | | | |
| | B: PC | | | | | |
| Example 4 | A: PEN | 1,700 | None | — | 3.5 | Not observed |
| | B: PEN | | | | | |
| Example 5 | A: Cyclic | 1,700 | None | 100 | 3.1 | Not observed |
| | olefin | | | | | |
| | B: Cyclic | | | | | |
| | olefin | | | | | |
| Example 6 | A: Cyclic | 500 | None | — | 1.1 | Not observed |
| | olefin | | | | | |
| | B: Cyclic | | | | | |
| | olefin | | | | | |
| Example 7 | A: Cyclic | 1,000 | None | — | 1.5 | Not observed |
| | olefin | | | | | |
| | B: Cyclic | | | | | |
| | olefin | | | | | |
| Example 8 | A: Cyclic | 30,000 | None | — | 2.4 | Not observed |
| | olefin | | | | | |
| | B: Cyclic | | | | | |
| | olefin | | | | | |
| Example 9 | A: Cyclic | 1,700 | None | 40 | 2.8 | Not observed |
| | olefin | | | | | |
| | B: Cyclic | | | | | |
| | olefin | | | | | |
| Comparative | A: Cyclic | — | None | — | Not | Not observed |
| Example 1 | olefin | | | | bonded | |
| | B: Cyclic | | | | | |
| | olefin | | | | | |
| Comparative | A: Cyclic | 1,700 | Used | — | 2.2 | Not observed |
| Example 2 | olefin | | | | | |
| | B: Cyclic | | | | | |
| | olefin | | | | | |
| Comparative | A: Cyclic | 400 | None | — | 0.5 | Not observed |
| Example 3 | olefin | | | | | |
| | B: Cyclic | | | | | |
| | olefin | | | | | |
| Comparative | A: Cyclic | 30,500 | None | — | 2.4 | Observed |
| Example 4 | olefin | | | | | |
| | B: Cyclic | | | | | |
| | olefin | | | | | |

PEN: Polyethylene naphthalate
PC: Polycarbonate

From Table 1 and FIG. 5, the following findings are obtained.

(a) In Examples 1 to 9 in which the films were subjected to corona treatment, the films can is bonded although the peel strength varies depending on the type of the films, whereas, in Comparative Example 1 in which the films were not subjected to corona treatment, the films is not be bonded. From this, it is found that the corona treatment for the film surfaces enables the films to be bonded together.

(b) Attention is drawn to Examples 1 to 4 in which the conditions for surface treatment are the same. In Example 2 in which a cyclic olefin film and a PEN film were bonded together, a high peel strength is obtained, as compared to those obtained in Examples 1, 3, and 4 in which other types of films were bonded together. From this, it is found that the bonding force varies depending on the type of the films bonded, and that excellent bonding force is obtained especially when a cyclic olefin film and a PEN film are bonded together.

(c) From a comparison between Comparative Example 2 in which the surfaces of the films were subjected to corona treatment and then a bonding agent was applied to the surfaces and the films were bonded together and Example 1 in which the surfaces of the films were subjected to corona treatment and the films were bonded together, it is found that the laminated materials in these Examples have an equivalent peel strength. From this, it is found that only the corona treatment for film surface achieves peel strength equivalent to that of the bonding agent.

(d) From a comparison between Examples 5 and 9 in which the laminated material was subjected to heat treatment and Example 1 in which the laminated material was not subjected to heat treatment, it is found that there is a tendency to improve remarkably the peel strength by conducting heat treatment. Further, from a comparison between Example 5 in which the heat treatment was conducted at 100° C. and Example 9 in which the heat treatment was conducted at 40° C., it is found that the increase of the temperature of the heat treatment can improve the peel strength. In this connection, it is noted that, when the heat treatment is conducted at a temperature higher than the glass transition temperature Tg of the cyclic olefin constituting the films, the laminated material may become deformed. Accordingly, for bonding the films together more strongly, it is preferred that the laminated material is subjected to heat treatment at 40° C. or higher. For bonding the films together more strongly while preventing the laminated material from suffering deformation, it is preferred that the laminated material is subjected to heat treatment at a temperature of 40° C. or higher and equal to or lower than the glass transition temperature Tg of the polymer material constituting the films.

(e) From FIG. 5, it is found that the peel strength rapidly increases at discharge energy of the corona treatment in the range of from 0 to 1,700 W/m²/min, and that the peel strength gradually increases at discharge energy in the range of 1,700 W/mm²/min or more. It is noted that, as can be seen from Table 1, the cyclic olefin film is likely to suffer deformation when the discharge energy of the corona treatment exceeds 30,000 W/m²/min. Accordingly, for bonding the films together more strongly while preventing the films from suffering deformation, it is preferred that the discharge energy of the corona treatment is 1,700 W/m²/min to 30,000 W/m²/min. When the surfaces of cyclic olefin films to be bonded are subjected to corona treatment at discharge energy of 1,700 W/m²/min to 30,000 W/m²/min, the cyclic olefin films bonded have peel strength of 1.7 N/20 mm to 2.4 N/20 mm.

Next, for examining the surface state after the corona treatment, the surface of an optical member was analyzed as follows.

### Reference Example

A ZEONOR film was subjected to corona treatment, and then subjected to chemical force microscope (CFM) surface analysis in which the surface was scanned by a probe of a scanning probe microscope (SPM) which had been chemically modified with —COOH, to observe the functional group distribution or activated state. As a result, it was found that a dangling bond was formed in the surface. Further, from the results of an analysis of the functional group amount on the surface by electron spectroscopy for chemical analysis (ESCA), an increase of oxygen-containing functional groups was confirmed.

With respect to the optical members, e.g., films, having surfaces highly activated, it is presumed that, merely by putting the activated surfaces into contact with each other, the optical members can be bonded together due to chemical bonding without using a bonding agent.

Hereinabove, the embodiments and Examples are described in detail, but the present invention is not limited to the above embodiments and Examples, and can be changed or modified based on the technical concept of the present application.

For example, the values or numbers mentioned in the above embodiments and Examples are merely examples, and values or numbers different from them can be used if desired.

In the above embodiments and Examples, an example is described in which the present application is applied to the laminated material used in optical applications, but the present invention can be applied to a laminated material used in other applications.

In the above embodiments and Examples, an example is described in which the present application is applied to the laminated material comprising two optical members bonded together and the method for producing the same, but the present application can be applied to a laminated material comprising three optical members or more bonded together and a method for producing the same.

In the above embodiments and Examples, an example is described in which the surfaces of the two optical members are modified by a corona treatment in the production of the laminated material. However, instead of the corona treatment, an ionizing radiation treatment which can achieve similar surface modification, such as an electron beam treatment or a low-temperature plasma treatment, may be used to one of the two members.

In the above embodiments, an example is described in which the present application is applied to the laminated material in which one optical member has a flat form in the surface thereof bonded to another and another optical member has an uneven shape in the surface thereof bonded, but the present invention can be applied to a laminated material in which each of the optical members bonded has an uneven shape in the surface thereof bonded to another.

In the above embodiments, an example is described in which the optical member has a lens formed in the surface thereof bonded to another, but the optical member mat, have an emboss or bead coating layer formed in the surface thereof bonded to another. The emboss is formed by, for example, an irregular uneven pattern formed in the roll surface used during the molding of optical member. The bead coating layer comprises, for example, part of particles, such as inorganic particles or organic particles, embedded in a resin material. Examples of optical members having formed an emboss or bead coating layer include a diffuser sheet and a light guide plate.

As described above, in embodiments of the present application, a surface to be bonded of a member is modified by a corona treatment and members are bonded together, and therefore the members can be bonded without using a bonding agent and without melting the members.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A laminated material comprising:
a plurality of members bonded together, each of the members including a polymer material,
wherein at least one of bonded surfaces of the members bonded together is subjected to a corona treatment.

2. The laminated material according to claim 1, wherein the plurality of members are composed of one type or two or more types of members.

3. The laminated material according to claim 1, wherein the polymer material is a cyclic olefin resin.

4. The laminated material according to claim 1, wherein at least one of the plurality of members is a retardation film.

5. The laminated material according to claim 1, wherein at least one of the plurality of members has an uneven surface bonded to another member.

6. The laminated material according to claim 1, wherein the members have a peel strength of 1.1 N/20 mm to 2.4 N/20 mm.

7. A wave plate comprising:
the laminated material according to claim 1.

8. An optical film comprising:
the laminated material according to claim 1.

9. A method for producing a laminated material, comprising:
subjecting to corona treatment a surface of at least one of two members, each of the two members including a polymer material; and
bonding the two members together through the surface subjected to the corona treatment.

10. The method according to claim 9, wherein the corona treatment is conducted at discharge energy of 500 W/m²/min to 30,000 W/m²/min.

11. The method according to claim 9, wherein the corona treatment is conducted at discharge energy of 1,000 W/m²/min to 20,000 W/m²/min.

12. The method according to claim 9, wherein the corona treatment is conducted at discharge energy of 1,700 W/m²/min to 20,000 W/m²/min.

13. The method according to claim 9, wherein the boding step is performed while subjecting at least one of the two members to heat treatment.

14. The method according to claim 9, further comprising, after the step for bonding, subjecting to heat treatment at least one of the two members bonded together.

15. The method according to claim 13, wherein the heat treatment is conducted at a temperature of 40° C. or higher and equal to or lower than the glass transition temperature of the polymer material constituting the member.

16. The method according to claim 14, wherein the heat treatment is conducted at a temperature of 40° C. or higher and equal to or lower than the glass transition temperature of the polymer material constituting the member.
